(19) United States
(12) Patent Application Publication
(10) Pub. No.: US 2019/0160397 A1
(43) Pub. Date: May 30, 2019

(54) MODULAR LIQUID WASTE TREATMENT INTEGRATED FIN MEMBERS, STRUCTURE, ASSEMBLY AND METHOD OF MANUFACTURE

(71) Applicant: PRESBY PATENT TRUST, Whitefield, NH (US)

(72) Inventor: David William PRESBY, Sugar Hill, NH (US)

(73) Assignee: PRESBY PATENT TRUST, Whitefield, NH (US)

(21) Appl. No.: 15/998,909

(22) PCT Filed: Feb. 16, 2017
(86) PCT No.: PCT/US2017/018109

§ 371 Date: Aug. 16, 2018

Related U.S. Application Data
(60) Provisional application No. 62/295,821, filed on Feb. 16, 2016.

(51) Int. Cl. B01D 29/00; B65H 16/02; E03F 3/00

(52) U.S. Cl. CPC B01D 29/0093; C02F 3/288; E03F 3/00; B65H 16/02

(57) ABSTRACT

A fin assembly apparatus which comprising a product dispensing stand for supporting a fabric product, a movable fin insertion apparatus for overlapping the fabric product and forming a fin opening, a movable fin sandwiching apparatus for forming a fin member, a pair of spaced apart guide tracks for supporting the movable fin sandwiching apparatus and the movable fin insertion apparatus, and a control panel for controlling operation of the fin assembly apparatus during manufacture of the fin member.

### FIELD OF THE INVENTION

The present invention relates to an automated system for manufacturing a fin structure which is suitable for treatment of liquid waste, and more particularly for treatment of wastewater and septic effluent.

### SUMMARY OF THE INVENTION

Wherefore, it is an object of the present invention to overcome the above mentioned shortcomings and drawbacks associated with the prior art.

Another object of the present invention is to provide a semi automated apparatus which facilitates manufacture of a fin member which forms part of a fin structure.

A further object of the present invention is to simplify the insertion of one or more perforated pipes and fiber, woodchips, styrofoam, etc., into a fin opening formed in an overlapped fabric product to assist with manufacture of a fin member.

Yet another object of the present invention is to provide a semi automated apparatus which facilitates manufacture of a series of fin members, e.g., two to eight fins for example, in order to form an integrated fin structure.

A still further object of the present invention is typically to insert a perforated pipe alongside a uniform amount of evenly distributed fiber, woodchips, styrofoam, etc., into a fin opening formed in an overlapped fabric product to assist with manufacture of a fin member in order to allow air to flow lengthwise into the fibers, woodchips, styrofoam, etc., which, in turn, filter more suspended solids, protect outer geotextile bacterial treatment surfaces and create relatively massive bacteria treatment areas when compared to prior art designs.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a diagrammatic perspective view of the fin assembly apparatus, according to the present invention, with the fin sealing apparatus, the fin insertion apparatus and the slidable tray, each located in their respective retracted positions;

FIG. 1A is a diagrammatic perspective view of the product dispensing stand of the fin assembly apparatus, according to the present invention;

FIG. 1B is a diagrammatic perspective view of the fin insertion apparatus and the slidable tray of the fin assembly apparatus, according to the present invention;

FIG. 1C is a diagrammatic perspective view of the fin sealing apparatus, according to the present invention;

FIG. 1D is a diagrammatic perspective view of the product dispensing stand of the fin assembly apparatus with pivotable stop arms supported in a retracted position;

FIG. 1E is a diagrammatic perspective view of the product dispensing stand of the fin assembly apparatus after the pivotable stop arms have been actuated to an extended position;

FIG. 2 is a diagrammatic left side perspective view of the fin assembly apparatus after the leading end of the fabric product is held by the product dispensing stand, while the fin sealing apparatus, fin insertion apparatus and the slidable tray are each in their respective retracted positions;

FIG. 2A is a diagrammatic left side perspective view of the fin assembly apparatus after the fin sealing apparatus has moved into its extended position to clamp the leading end of the fabric product to the product dispensing stand while the fin insertion apparatus and the slidable tray are still each in their respective retracted positions;

FIG. 3 is a diagrammatic top left perspective view of the fin assembly apparatus with the fin sealing apparatus in its extended position with the fin insertion apparatus being moved into its extended positions while the slidable tray still remains in its retracted position;

FIG. 4 is a diagrammatic left side perspective view of the fin assembly apparatus with each of the fin sealing apparatus, the fin insertion apparatus and the slidable tray shown in their respective extended positions;

FIG. 5 is a diagrammatic top left perspective view, of the fin assembly apparatus of FIG. 4, following lowering of the vertically movable clamping device into its extended position into engagement with the planar table of the fin sealing apparatus;

FIG. 6 is a diagrammatic top left perspective view of the vertically movable clamping device in engagement with the planar table while both the fin insertion apparatus and the slidable tray are each being moved back toward their respective fully retracted positions;

FIG. 7 is a diagrammatic left side perspective view of the fin assembly as the fin sealing apparatus is moving from its extended position toward its retracted position, following vertical raising of the vertically movable clamping device into its retracted position spaced from the planar table;

FIG. 8 is a diagrammatic left side perspective view of the fin assembly once the fin sealing apparatus reaches its extended position and after the manufactured fin member falls off of the planar table and is thereafter partially supported by the floor and the product dispensing stand;

FIG. 9 is a diagrammatic perspective upper view of fiber and a perforated plastic pipe supported by the slidable tray;

FIG. 9a is a diagrammatic perspective left side view of the fiber and the perforated plastic pipe supported by the slidable tray of FIG. 9;

FIG. 10 is a diagrammatic perspective view of a completed fin structure, manufactured by the fin assembly method according to the present invention; and

FIG. 11 is a diagrammatic perspective view of two completed fin structures, manufactured by the fin assembly according to the present invention, arranged with one another to form a completed fin assembly for treatment of liquid waste, and more particularly for treatment of wastewater and septic effluent.

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE PREFERRED EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention.

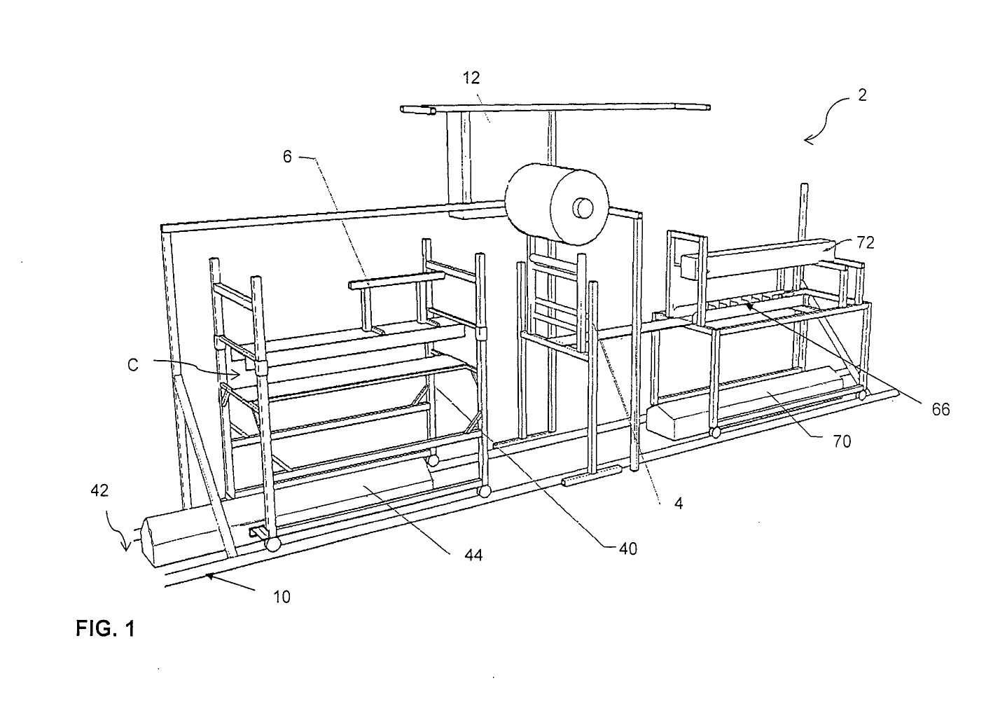

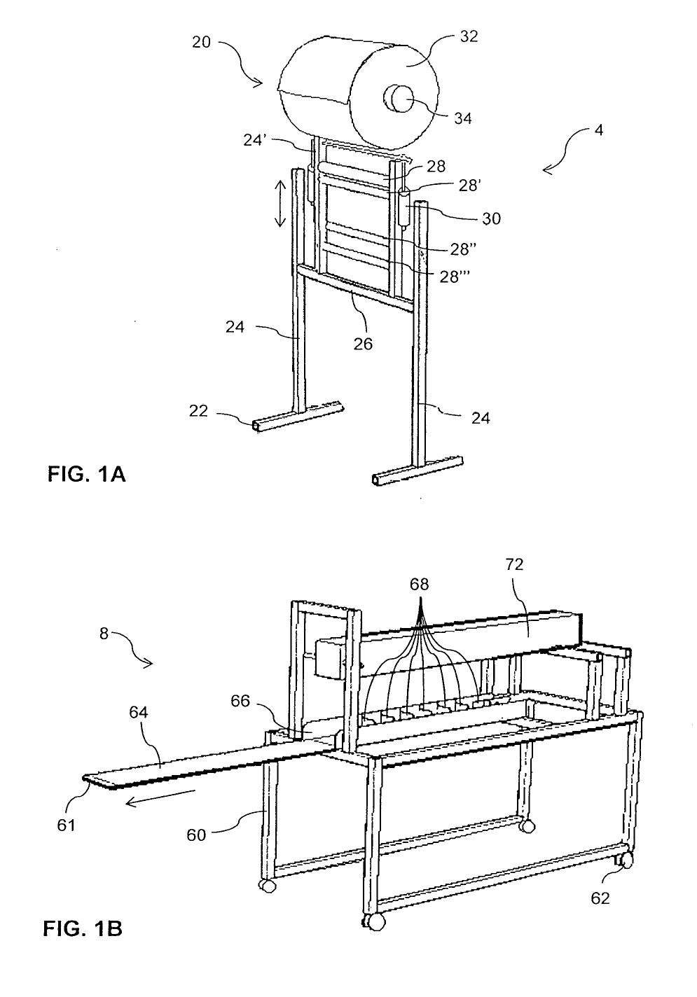

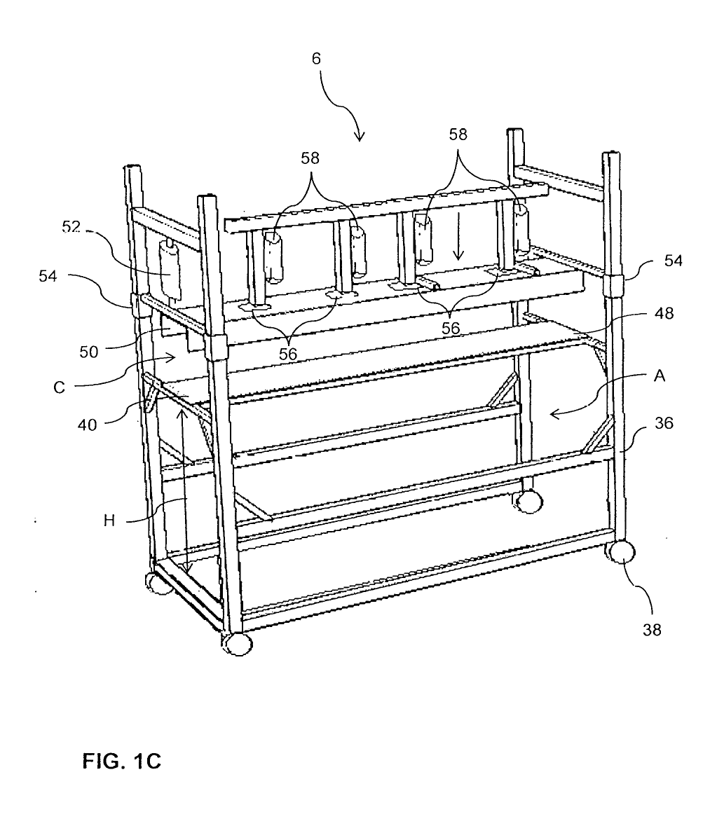

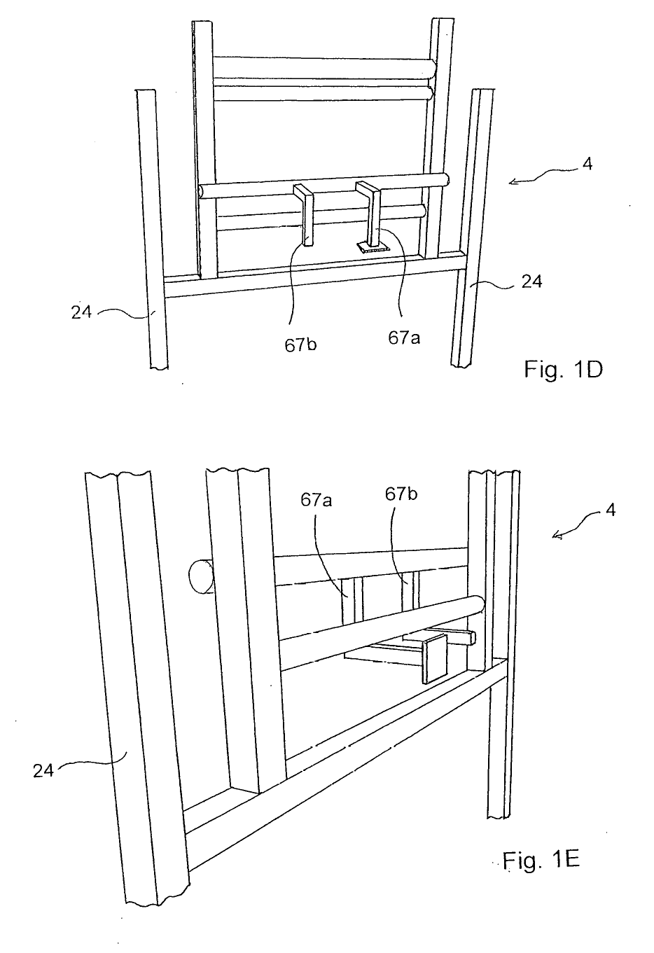

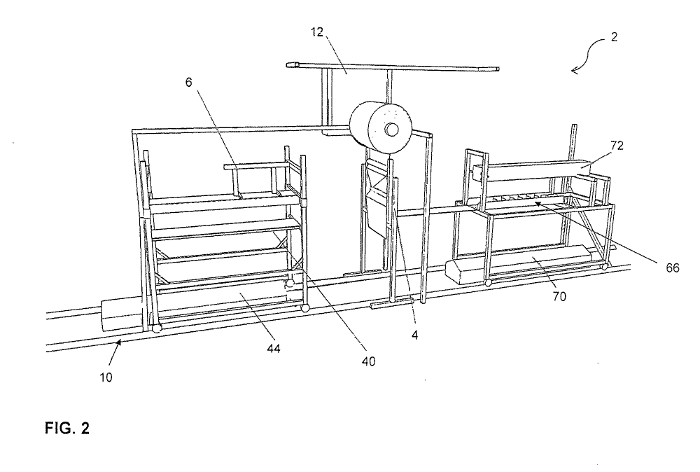

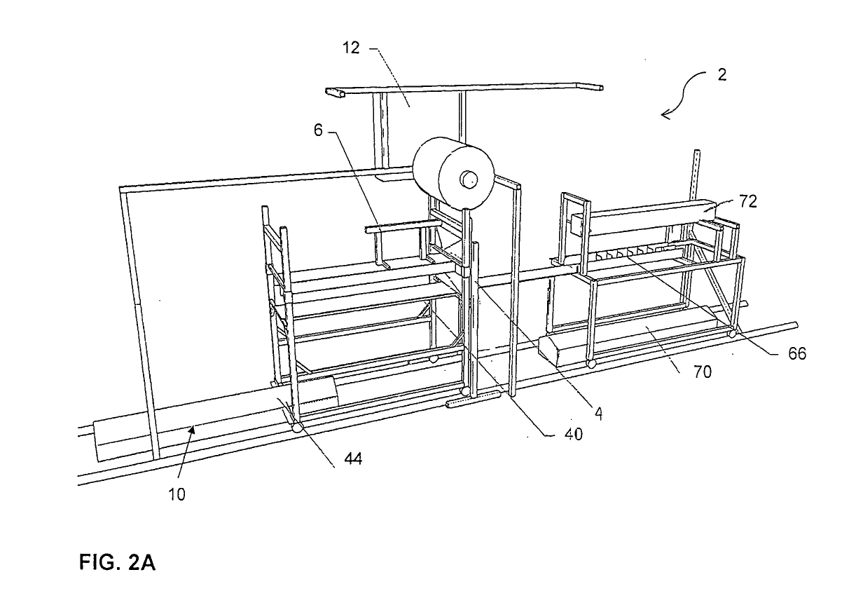

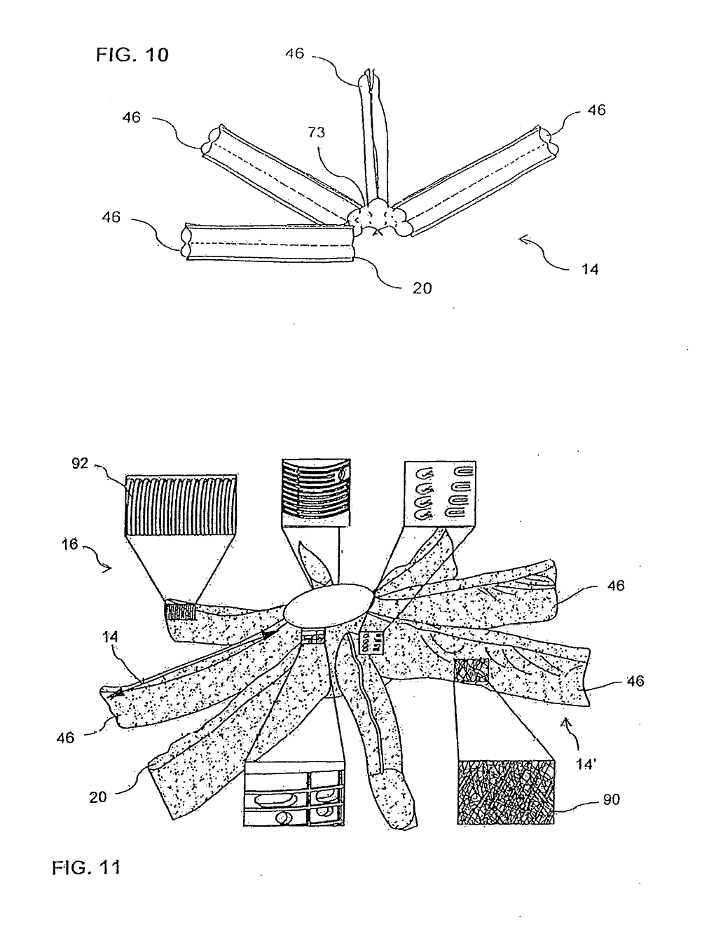

Turning now to FIGS. 1, 1A, 1B, 1C and 2, for example, a brief description concerning the various components of the present invention will now be briefly discussed. As can be seen in this embodiment, the fin assembly apparatus 2 generally comprises five major components, namely, a product dispensing stand 4, a fin sandwiching apparatus 6, a fin insertion apparatus 8, a pair of spaced apart guide tracks 10 and a control panel 12 for controlling operation of the fin assembly apparatus 2. Each one of these components will be discussed in further detail below and then such disclosure will be followed by a detailed discussion concerning operation of the fin assembly apparatus 2 to manufacture two or more separate fin structures 46 (see FIG. 10) which can then be arranged to form a completed ENVIROFIN® modular liquid waste treatment fin assembly 16 (see FIG. 11) for treatment of liquid waste, and more particularly for treatment of wastewater and septic effluent.

As shown in FIGS. 1-8, the fin assembly apparatus 2 includes the stationary product dispensing stand 4 for periodically dispensing a fabric product 20, such as a geotextile, a porous membrane (net or mesh) or some other similar fabric, during manufacture of the fin structure 14 (see FIG. 10). The product dispensing stand 4 generally comprises a support framework which includes a base 22 and a first pair of vertical supports 24 which are permanently attached to and extend vertically from a central region of the base 22. A transverse arm 26 extends between and fixedly interconnects an upper section of the pair of vertical supports 24 with one another. The transverse arm 26, in turn, fixedly supports a second pair of spaced apart vertical supports 24′ which, in turn, typically support first, second, third and fourth spaced apart cylindrical rods or rolls 28, 28′, 28″, 28′″ that are supported by and extend between the second pair of spaced apart vertical supports 24′. At least the second rod 28′ is rotatable. The first, the second, the third and the fourth spaced apart cylindrical rods or rolls 28, 28′, 28″, 28′″ are arranged so as to facilitate dispensing of the fabric product 20 during manufacture of the fin structure 14 (see FIG. 10), as discussed below in further detail. It is to appreciated that the number and location of the spaced apart cylindrical rods or rolls can vary without departing from the spirit and scope of the present invention.

The first cylindrical rod or roll 28 is support by a brake (air or hydraulic) cylinder 30 (see FIG. 1A) and is movable, via the brake cylinder 30, into engagement with the second rotatable roll 28′. When the brake cylinder 30 is actuated by the control panel 12, the first stationary cylindrical rod or roll 28 is forced against the second rotatable roll 28′, by the brake cylinder 30, to clamp the fabric product 20 therebetween and prevent further rolling of the second rotatable roll 28′ as well as dispensing of the fabric product 20 from the product roll 32.

A vertically uppermost section of a first one of the second pair of apart vertical supports 24′ supports a rotatable dispensing roller 34 onto which a desired roll 32 of the fabric product to be dispensed is supported. A leading end of the fabric product 20 extends from the roll 32 of the fabric product 20 and partially wraps around each of the first, the second, the third and the fourth spaced apart cylindrical rods or rolls 28, 28′, 28″, 28′″, in a general serpentine fashion, and is then “clamped” to the product dispensing stand 4, as discussed below, in order to temporarily secure the leading end of the fabric product 20 to the product dispensing stand 4 during manufacture of the fin structure 14. The roll 32 of the fabric product 20 has a desired width, but it is to be appreciated that the fabric product width can vary depending upon the particular application. The product dispensing stand 4 typically has a width which is slightly wider than the width of the fabric product, but it is to be appreciated that the width of the product dispensing stand 4 can vary depending upon the particular application.

As also shown in FIGS. 1-8, the fin sandwiching apparatus 6 generally comprises a framework 36 comprising a plurality of, e.g., typically four, vertical legs and transverse arms which are rigidly connected to one another to form the framework 36. A vertically lower most portion of each leg of the fin sandwiching apparatus 6 typically supports a respective guide roller 38 which facilitates rolling of the fin sandwiching apparatus 6 forward and backward along the pair of spaced apart guide tracks 10, as discussed below in further detail. A generally planar table 40 is supported by an intermediate section of the fin sandwiching apparatus 6, spaced from the floor 42. The generally planar table 40 has a width which is typically wider than the width of the fabric product 20, e.g., the planar table 40 typically has a sufficient width, for example, the purpose of which will become apparent from the following description.

A height H of the generally planar table 40 from the floor 42 is such that a temporary storage area A is formed between the bottom surface of the generally planar table 40 and the floor 42, between the vertically lower portions of each of the opposed legs of the fin sandwiching apparatus 6 and between the product dispensing stand 4 and a first drive 44. This temporary storage area A is sufficiently sized so as to readily accommodate and temporarily store typically a plurality of manufactured fin members 46, as discussed below in further detail.

A leading surface of the fin sandwiching apparatus 6 supports a horizontal transverse clamping arm 48 which is arranged to engage with the adjacent surface of the transverse arm 26 of the product dispensing stand 4 to temporarily clamp and secure the leading end of the fabric product 20 to the product dispensing stand 4 during manufacture of the fin structure 14. Either one or both mating surfaces of the transverse arms 26, 48 can accommodate an elastic or a friction member (not shown) which prevents relative sliding movement of the fabric product 20 with respect to the two mating transverse arms 26, 48.

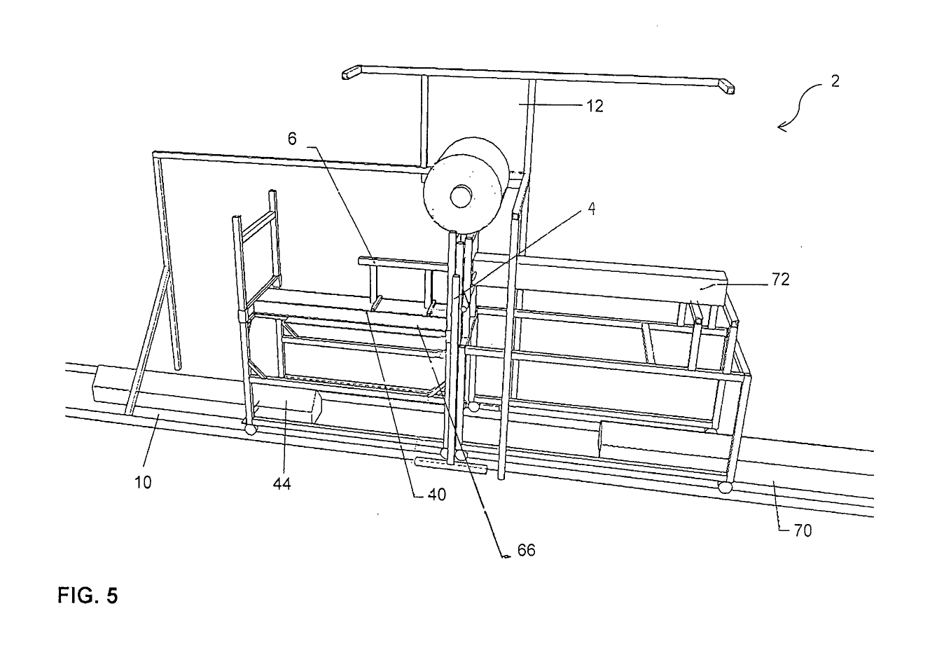

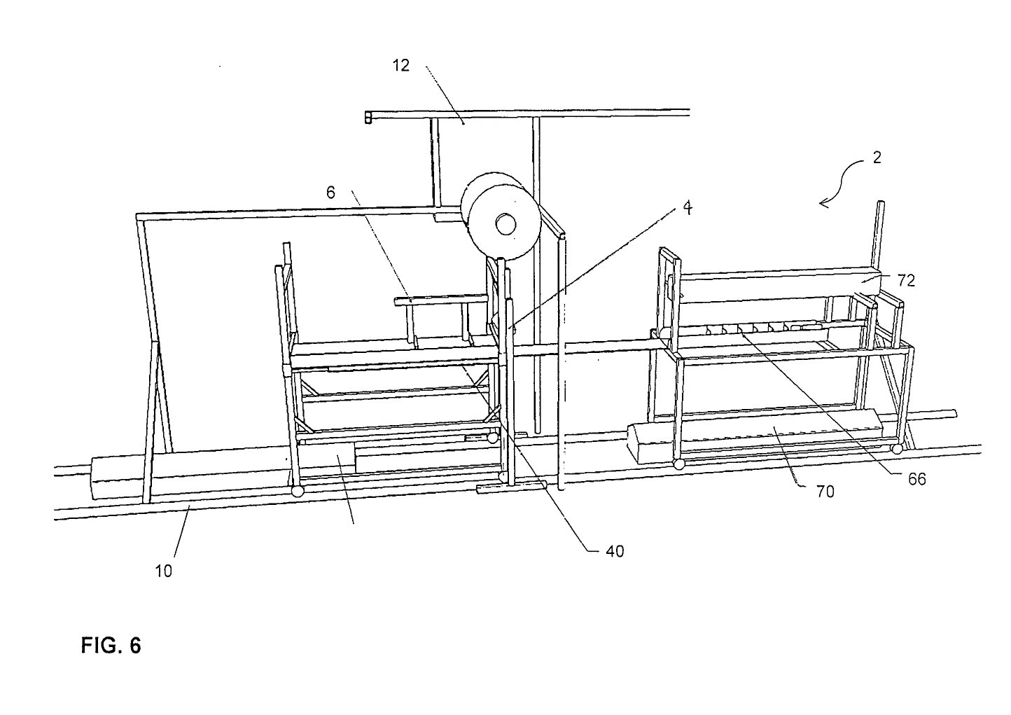

A vertically inverted U-shaped movable clamping device 50 is supported by the legs of the framework of the fin sandwiching apparatus 6 vertically above the planar table 40. The movable clamping device 50 has a width which is typically slightly less than the width of the fabric product 20. The vertically movable clamping device 50 has a vertically retracted position (as shown in FIGS. 1-4, for example), in which the vertically movable clamping device 50 is spaced from the planar table 40 and defines an adjustable cavity C therebetween, which facilitates assembly of the fin structure 14, and an extended position (shown in FIGS. 5 and 6), in which the vertically movable clamping device 50 is brought into contact with the planar table 40 in order to reduce the size of the cavity C and seal or facilitate stitching of the overlapped lateral edges of the fabric product 20 with one another. At least one seal (air or hydraulic for example) cylinder 52, preferably two or more seal cylinders is/are supported by the framework of the fin sandwiching apparatus 6 to facilitate moving the vertically movable clamping device 50 from its retracted position into its extended position, and vice versa. Each of the four corners of the vertically movable clamping device 50 is coupled to the respective vertical leg of fin sandwiching apparatus 6 by a respective slidable bearing member 54 which facilitates raising and lowering of the vertically movable clamping device 50 by the at least one seal cylinder 52.

A plurality of spaced apart apertures 56, typically each aperture 56 is equally spaced from each adjacent aperture 56 but such equal spacing is not required, are formed in the top surface of the vertically movable clamping device 50 and spaced from one another. Each of the spaced apart apertures 56, typically is equally spaced from one another, extends completely through the top surface of the vertically movable clamping device 50 and is formed generally centrally along the top surface of the vertically movable clamping device 50 between the opposed lateral edges thereof. A plurality of industrial hang tag guns, barb or wicket dispensing or fastening guns or devices 58 (only diagrammatically shown), one respectively associated with each one of the spaced apart apertures 56, are supported by the vertically movable clamping device 50 of the fin sandwiching apparatus 6 and provided for stitching opposed surfaces of the overlapped fabric product 20 with one another, in a conventional manner, during manufacture of a respective fin member 46.

During operation of the fin sandwiching apparatus 6, the vertically movable clamping device 50 is normally located vertically above and spaced away from the planar table 40 (as shown in FIGS. 1-4, for example) to facilitate assembly of a fin member 46 of the fin structure 14. After a fin member 46 of the fin structure 14 is assembled within the cavity C, the vertically movable clamping device 50 is then lowered into its extended position, by the at least one seal cylinder 52, with its perimeter edge in engagement with the planar table 40 so as to clamp the overlapped lateral edges of the fabric product 20 with one another (see FIGS. 5 and 6). Thereafter, either the overlapped lateral edges of the fabric product 20, sandwiched between the movable clamping device 50 and the planar table 40, can be stitched, stapled, glued, taped, or otherwise fastened to one another by a sewing machine, stapling equipment, gluing equipment, taping equipment, a heating element (not shown), i.e., supported by a perimeter edge, of the fin sandwiching apparatus 6 that is sufficiently heated in order to bond and fuse the overlapped lateral edges of the fabric product 20, located between the movable clamping device 50 and the planar table 40, with one another.

As also shown in FIGS. 1-4, the fin insertion apparatus 8 generally comprises a framework 60 comprising a plurality of, e.g., typically four, vertical legs and transverse arms which are rigidly connected to one another to form the framework 60. A vertically lower most portion of each leg of the fin insertion apparatus 8 typically supports a respective guide roller 62 which facilitates rolling of the fin insertion apparatus 8 forward and backward along the pair of spaced apart guide tracks 10, as discussed below in further detail. A generally planar tongue member 64 is supported by an intermediate section of the framework 60 of the fin insertion apparatus 8 and projects from the leading end of the fin insertion apparatus 8. The generally planar tongue member 64 extends parallel to the generally planar table 40 of the fin sandwiching apparatus 6 but is located slightly vertically above the planar table 40. The displacement between the tongue member 64 and the generally planar table 40 of the fin sandwiching apparatus 6 permits relative horizontal movement of the generally planar tongue member 64 with respect to the generally planar table 40. A layer of the fabric material is located therebetween, as the fin insertion apparatus 8 moves relative to the fin sandwiching apparatus 6, the purpose of which will become apparent from the following description.

The generally planar tongue member 64 has a width which is typically less than the width of the planar table 40 and the width of the vertically movable clamping device 50. Preferably, the leading edge 61 of the generally planar tongue member 64 is provided with either a roller, an anti-friction layer or coating, e.g., Teflon®, or some other smooth low friction surface. This leading edge 61 facilitates sliding of the fabric product 20 over the generally planar tongue member 64 during assembly of the fin structure 14, as discussed below in further detail.

In addition, a slidable tray 66 is supported by the framework 60 of the fin insertion apparatus 8 and slidable along a vertical upper surface of the generally planar tongue member 64. The slidable tray 66 is normally supported by the fin insertion apparatus 8 in a retracted position, located closely adjacent to a trailing end of the fin insertion apparatus 8 and remote from a leading end of the generally planar tongue member 64. The slidable tray 66 is equipped with at least one hinge member 68, and preferably a plurality of hinge members 68. The bases of each of the hinge members 68 are permanently attached sequentially along a first vertical side wall of the slidable tray 66. The hinge members 68 extend outwardly from the first vertical side wall and only partially across the width of the slidable tray 66, so as to leave a gap between a leading edge of the extended hinge members 68 and a second vertical side wall of the slidable tray 66. The gap being sufficiently sized to accommodate at least one perforated plastic pipe 92. It is to appreciated that two or more perforated plastic pipes 92 can be simultaneously inserted by the slidable tray 66 or, alternatively, the slidable tray 66 can only insert fiber, woodchips, styrofoam, etc., without inserting any perforated plastic pipe 92.

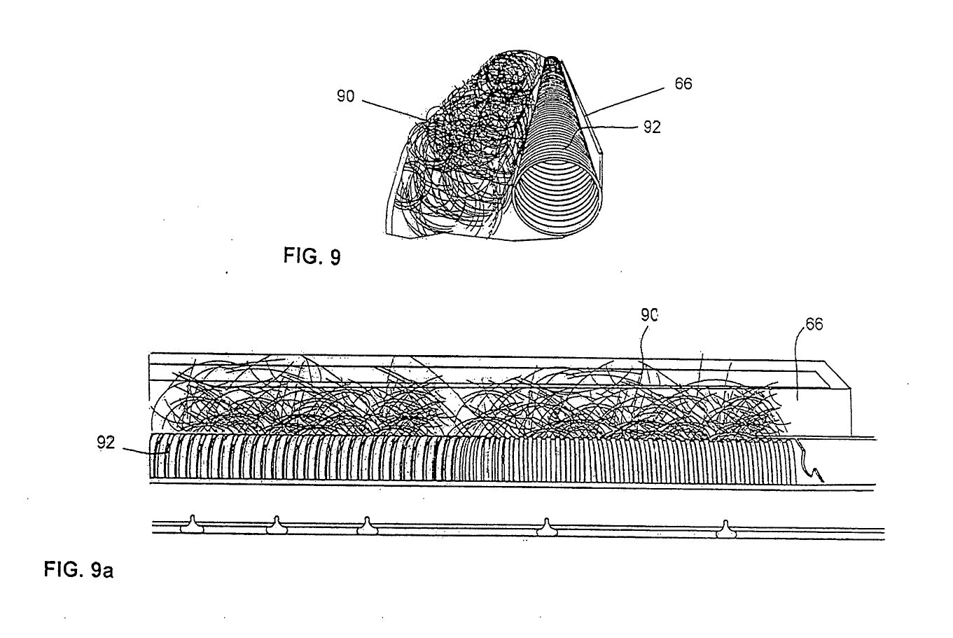

Each of the plurality of spaced apart hinge members 68 is only permitted to pivot about 90 degrees relative to the vertical side wall of the slidable tray 66, from a first position, in which the hinge members 68 extend normal to the first vertical side wall, toward a second position, in which the hinge members 68 extend parallel to the first vertical side wall. That is, the hinge members 68 can pivot into a pivoted position toward the leading end of the slidable tray 66 in which the hinge members 68 generally abut against, and are arranged parallel to, the vertical side wall to assist with removal of the slidable tray 66 following loading of the fiber, woodchips, styrofoam, etc., 90 into the cavity C. Initially, when the plurality of spaced apart hinge members 68 extend normally to the side wall, they facilitate uniform loading of the fiber, woodchips, styrofoam, etc., 90 into the cavity C. Then, when the plurality of spaced apart hinge members 68 extend generally parallel to the side wall, the hinge members 68 facilitate withdrawal of the slidable tray 66 from the cavity C without pulling, compacting, disrupting and/or withdrawing the loaded fiber, woodchips, styrofoam, etc., 90. Thus, typically in operation, as shown in FIGS. 9 and 9a, the fiber, woodchips, styrofoam, etc., 90 is uniformly loaded on and carried by the hinge members 68 while the perforated plastic pipe 92 (e.g., 1-6 inch pipe for example), is located between the free leading ends of the hinge members 68 and the second vertical side wall of the slidable tray 66.

During assembly, when the slidable tray 66 is actuated by the control panel 12, the slidable tray 66 is maneuvered from its retracted position into its extended position. The slidable tray 66 slides along the top surface of the generally planar tongue member 64, from the trailing end toward the leading end of the generally planar tongue member 64. Extending in this manner, the slidable tray 66 facilitates insertion and loading of both the carried pipe 92 and uniformly deposited fiber, woodchips, styrofoam, etc., 90 into the fin opening P formed by the overlapped fabric product 20.

As briefly discussed above, and shown in FIGS. 1-8, the fin assembly apparatus 2 includes the pair of spaced apart guide tracks 10 which are positioned so as to be generally longitudinally straddled, on both sides thereof, by the base 22 of the product dispensing stand 4. The opposed ends of the pair of spaced apart guide tracks 10 can be provided with a stop member which prevents further undesired travel along the pair of spaced apart guide tracks 10. As shown, the fin sandwiching apparatus 6 and the fin insertion apparatus 8 are both supported and guided by their respective guide rollers 38, 62 along the pair of spaced apart guide tracks 10 so as to be movable into their extended positions, located closely adjacent to the product dispensing stand 4, and their retracted positions, located remote and spaced from the product dispensing stand 4, and a further detailed discussion concerning the purpose and function of each position of the fin sandwiching apparatus 6 and the fin insertion apparatus 8 is provided below.

The first (chain) drive 44 is coupled to the fin sandwiching apparatus 6 for conveying the fin sandwiching apparatus 6 along the pair of spaced apart guide tracks 10 into either its extended position, located closely adjacent to the product dispensing stand 4, or its retracted position, located remote from the product dispensing stand 4, and vice versa. A trailing end of the fin sandwiching apparatus 6 is coupled to a section of the endless chain of the first drive 44 in a conventional manner. When the endless chain of the first drive 44 is driven by a first motor (not shown), controlled by the control panel 12, in a first direction, the first drive 44 moves the fin sandwiching apparatus 6 toward its extended position located closely adjacent the product dispensing stand 4. Similarly, when the endless chain of the first drive 44 is driven in an opposite second direction, the first drive 44 moves the fin sandwiching apparatus 6 toward its retracted position spaced furthest away from the product dispensing stand 4.

A second (chain) drive 70 is coupled to the fin insertion apparatus 8 for conveying the fin insertion apparatus 8 along the pair of spaced apart guide tracks 10 into either its extended position, located closely adjacent to the product dispensing stand 4, or its retracted position, located remote from the product dispensing stand 4, or vice versa. A trailing end of the fin insertion apparatus 8 is coupled to a section of the endless chain of the second drive 70 in a conventional manner. When the endless chain of the second drive 70 is driven by a second motor (not shown), controlled by the control panel 12, in a first direction, the second drive 70 moves fin insertion apparatus 8 toward its extended position located closely adjacent the product dispensing stand 4. Then, when the endless chain of the second drive 70 is driven in an opposite second direction, the second drive 70 moves the fin insertion apparatus 8 toward its retracted position spaced furthest away from the product dispensing stand 4.

A third (chain) drive 72 is supported by an upper portion of the framework of the fin insertion apparatus 8 for conveying the slidable tray 66 along the upper top surface of the generally planar tongue member 64. This third drive 72 facilitates conveying the slidable tray 66 from its retracted position, located adjacent the trailing end of the fin insertion apparatus 8, into its extended position, located adjacent the leading end of and generally overlying the generally planar tongue member 64, for inserting both the pipe 92 and/or loose fiber, woodchips, styrofoam, etc., 90 into the partially formed fin member 46. A trailing end of the slidable tray 66 is coupled to a section of the endless chain of the third drive 72 in a conventional manner. When the endless chain of the third drive 72 is driven by a third motor (not shown), controlled by the control panel 12, in a first direction, the third drive 72 moves the slidable tray 66 toward its extended position in which the slidable tray 66 overlies the generally planar tongue member 64. Then, when contrary instructions are received from the control panel 12, the endless chain of the third drive 72 is driven in an opposite second direction, and the third drive 72 moves the slidable tray 66 toward its retracted position adjacent the trailing end of the fin insertion apparatus 8.

It is to be appreciated that each one of the first, the second and the third drives 44, 70, 72 are typically operated independently of one another. Moreover, while chain drives are contemplated and disclosed herein, it is to be appreciated that a variety of other conventional drive mechanisms can be utilized, instead of the chain drives, for driving the associated assemblies into their extended and retracted positions, and vice versa, without departing from the spirit and scope of the present invention.

Now that a brief discussion of the major components has been provided, a detailed description concerning operation of the fin assembly apparatus 2, for manufacture of the fin structure 14, will now be provided. As generally shown in FIGS. 1-4, a roll 32 of the fabric product 20 to be dispensed, is supported by the dispensing roller 34 of the product dispensing stand 4,

As shown in FIG. 2, initially, the leading end of the fabric product 20 is threaded partially around each of the first, the second, the third tensioning cylindrical rods or rolls 28, 28′, 28″, 28′″ which are located to engage with the fabric product 20 to smooth out the fabric product 20, as it is dispensed, and apply sufficient tension thereto during dispensing of the fabric product 20 and assembly of a fin member 46 of the fin structure 14. It is to appreciated that the path along which the fabric product 20 is dispensed from the product roll 32 can vary without departing from the spirit and scope of the present invention. As discussed above, the product dispensing stand 4 is equipped with the brake cylinder 30, to clamp the fabric product 20, when desired, and prevent undesired further dispensing of the fabric product 20 from the product roll 32. As noted above, operation of the brake cylinder 30 is controlled by the control panel 12, which may be either manually operated or include appropriate computer software so as to automate control of the process. After wrapping the fabric product 20 around the cylindrical rods or rolls 28, 28′, 28″, 28′″, the leading end of the fabric product 20 extends down along a side surface of the transverse arm 26 of the product dispensing stand 4 by approximately 4 inches or so.

Next, as shown in FIG. 2A, the control panel 12 actuates the first drive 44 to move the fin sandwiching apparatus 6 from its retracted position into its extended position located. Thus moving the fin sandwiching apparatus 6 into abutting engagement with the product dispensing stand 4, while the fin insertion apparatus 8 still remains in its retracted position with the leading end of the generally planar tongue member 64 located closely adjacent but slightly spaced from the product dispensing stand 4. As the fin sandwiching apparatus 6 is moved into its extended position, the transverse arm 48, supported by the leading surface of the fin sandwiching apparatus 6, engages and temporarily clamps the leading end of the fabric product 20 against the adjacent surface of the transverse arm 26 of the product dispensing stand 4.

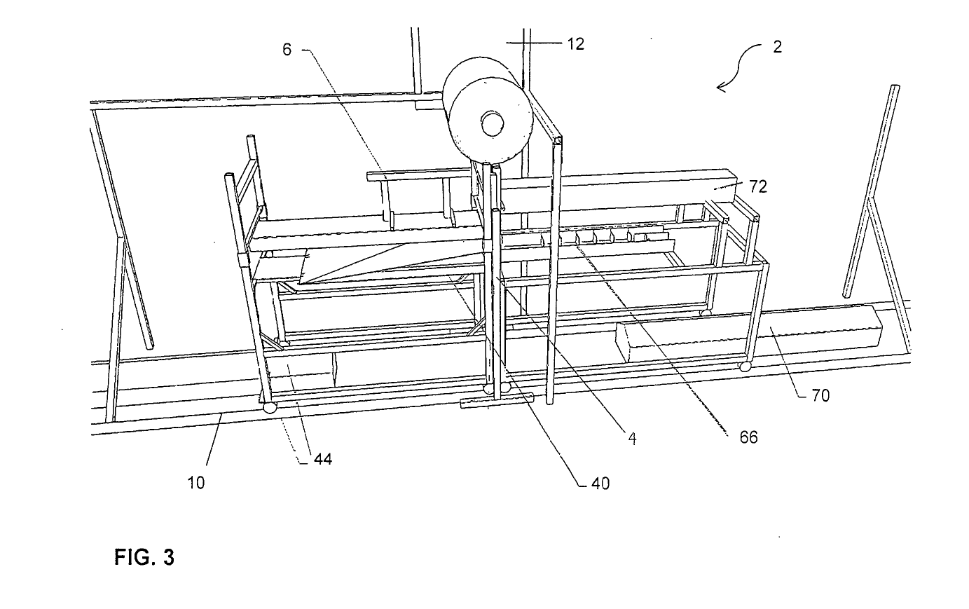

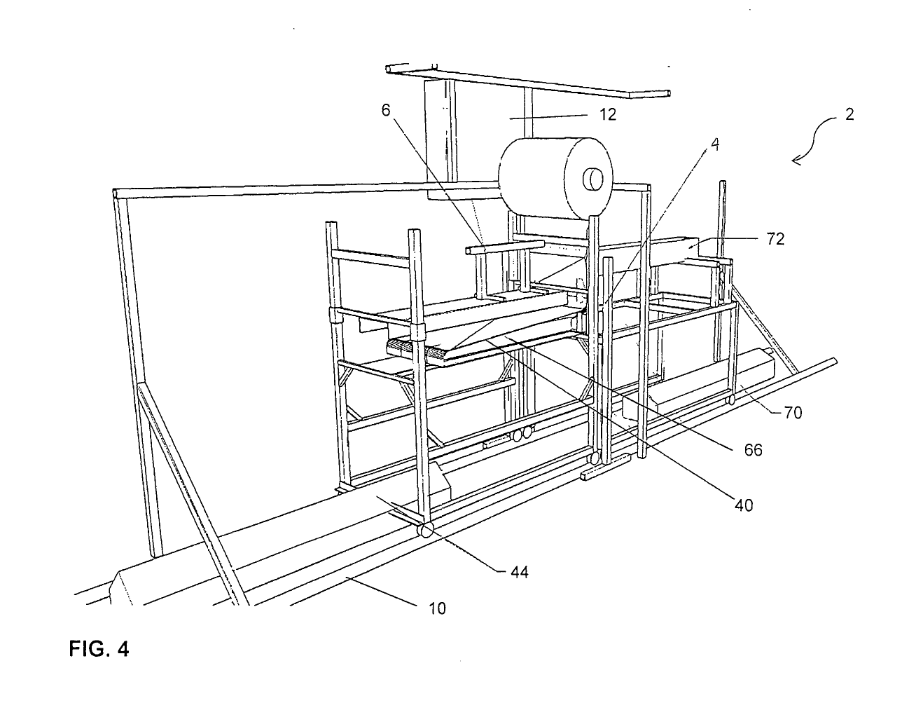

The control panel 12 then actuates the fin insertion apparatus 8 which, as shown in FIGS. 3 and 4, commences gradual movement of the fin insertion apparatus 8 from its retracted position toward its extended position. As the fin insertion apparatus 8 moves from its retracted position toward its extended position, as generally shown in FIGS. 3 and 4, the brake cylinder 30 unclamps the fabric product 20 while at the same time the leading end of the generally planar tongue member 64 engages with the fabric product 20 and commences unrolling of the fabric product 20, from the product roll 32, and pushing and forcing the fabric product 20 into the cavity C defined between the top surface of the planar table 40 and downwardly facing bottom surface of the vertically movable clamping device 50 of the fin sandwiching apparatus 6.

As the fabric product 20 is forced by the generally planar tongue member 64 into the cavity C, a first layer of the fabric product 20 is located between the top surface of the generally planar table 40 and the bottom surface of the generally planar tongue member 64, while a second overlapped layer of the fabric product 20 is located between the top surface of the generally planar tongue member 64 and the bottom surface of the vertically movable clamping device 50 of the fin sandwiching apparatus 6. As the fin insertion apparatus 8 continues to move from its retracted position to its extended position, the generally planar tongue member 64 continues facilitating unrolling of the fabric product 20 and further inserting of the fabric product 20 into the cavity and toward the opposite trailing end of the fin sandwiching apparatus 6.

Once the generally planar tongue member 64 of the fin insertion apparatus 8 reaches its fully extended position, the fabric product 20 extends substantially along the top surface of the generally planar table 40 of the fin sandwiching apparatus 6. The fabric product 20 wraps around the leading end 61 of the generally planar tongue member 64 and then returns back along the top surface of the generally planar tongue member 64 back toward the fourth cylindrical rod or roll 28′″ of the product dispensing stand 4. As a result of such arrangement, the fabric product 20 thereby wraps around the generally planar tongue member 64 and doubles back toward the product dispensing stand 4.

Due to the vertical spacing of the fourth cylindrical rod or roll 28′″ of the product dispensing stand 4 from the generally planar table 40 of the fin sandwiching apparatus 6, the overlapped second layer of the fabric product 20 is spaced from the top surface of the generally planar tongue member 64. This spacing thereby forms and defines a “fin opening” P between the overlapped second layer of the fabric product 20 and the top surface of the generally planar tongue member 64. This fin opening P is sufficiently large enough to permit insertion of the slidable tray 66, between the overlapped second layer of the fabric product 20 and the generally planar tongue member 64.

After the fin opening P is formed, the control panel 12 then actuates the seal cylinder 52 to move the vertically movable clamping device 50 from its spaced apart retracted position into its extended position in which the vertically movable clamping device 50 is vertically lowered so as to engage with the generally planar table 40 of the fin sandwiching apparatus 6. As the vertically movable clamping device 50 is lowered, the perimeter edges of the vertically movable clamping device 50 eventually engage with the lateral edges of the overlapped fabric product 20 and firmly sandwiches the lateral edges of the overlapped fabric product 20 between a perimeter edge of the vertically movable clamping device 50 and the planar table 40 of the fin sandwiching apparatus 6.

Next, the two lateral perimeter edges of the fabric product 20 are either sewn or stitched to one another by conventional sewing equipment (not shown). Alternatively the two lateral perimeter edges of the fabric product 20 are sufficiently heated, via a heated perimeter edge of the vertically movable clamping device 50, which causes the overlapped lateral edges of the fabric product 20 to fuse and be bonded with one another. Alternatively, it is to be appreciated that the two lateral perimeter edges of the fabric product 20 may be stapled, glued, taped or otherwise fastened to one another by conventional stapling, gluing, taping or fastening equipment (not shown), activated by the control device 12, without departing from the spirit and scope of the present invention. In each embodiment, the stitching, bonding, sewing, stapling, gluing, taping, fastening, etc., are provided along the two lateral perimeter edges of the fabric product 20 to permanently secure those overlapped edges to one another.

After the two lateral perimeter edges of the fabric product 20 are secured or fastened to one another, the control panel 12 then actuates the third drive 72 to commence movement of the slidable tray 66 from its retracted position, located closely adjacent the trailing end of the fin insertion apparatus 8 to its extended position, overlapping the generally planar tongue member 64 with the leading end of the slidable tray 66. As the slidable tray 66 moves toward its extended position, located closely adjacent to the leading end of the generally planar tongue member 64, the slidable tray 66 transports and loads the carried pipe 92 and/or the fiber, woodchips, styrofoam, etc., 90 into the fin opening P formed between the overlapped second layer of the fabric product 20 and the generally planar tongue member 64.

Once the slidable tray 66 reaches its fully extended position, the pipe 92 and/or the fiber, woodchips, styrofoam, etc., 90 are each fully loaded and accommodated within the fin opening P formed between the overlapped second layer of the fabric product 20 and the generally planar tongue member 64. After this occurs, the control panel 12 then actuates pivotable stop arms 67a, 67b, supported by the product dispensing stand 4, to move the stop arms 67a, 67b from their normally retracted positions (see FIG. 1D) into their extended positions (see FIG. 1E) in abutting engagement with a trailing end of the pipe 92 and the fiber, woodchips, styrofoam, etc., 90. The stop arm 67a has a plate that, when in its extended position, abuts against the fiber, woodchips, styrofoam, etc., 90. Similarly the stop arm 67b, when in its extended position, abuts against the trailing end of the pipe 92. The stop arms 67a, 67b in their extended positions prevent the pipe 92 and the fiber, woodchips, styrofoam, etc., 90 from being withdrawn along with the slidable tray 66 when the slidable tray 66 is withdrawn from the fin opening P.

After the stop arms 67a, 67b are located in their extended position in abutting engagement with a trailing end of the pipe 92 and/or the fiber, woodchips, styrofoam, etc., 90, the control panel 12 then actuates the third drive 72 to move the slidable tray 66 back toward its retracted position before withdrawal of the generally planar tongue member 64 from the fin opening P formed between the overlapped second layer of the fabric product 20 and the generally planar tongue member 64. It is to be appreciated, however, that the second drive 70 may be either sequentially actuated, after partial or completed movement of the slidable tray 66 into its retracted position or may be simultaneously actuated, during actuation of the third drive 72, to simultaneously withdraw the fin insertion apparatus 8 from the cavity C, without departing from the spirit and scope of the present invention. Alternatively, it is to be appreciated that the second drive 70 may be actuated before the third drive 72 is actuated to move the fin insertion apparatus 8 toward its retracted position before movement of the slidable tray 66 into its retracted position, without departing from the spirit and scope of the present invention. As soon as the slidable tray 66 reaches its retracted position, an operator is then able to load another section of pipe 92 and/or additional fiber, woodchips, styrofoam, etc., 90 onto the slidable tray 66 for insertion into the next fin opening P to be formed by the fabric product 20, as described below in further detail. It is to appreciated that the slidable tray 66 may possibly be inserted into the fin opening P before the two opposed lateral perimeter edges of the fabric product 20 are either sewn, stitched, glued, taped, stapled, secured or otherwise fastened to one another, without departing from the spirit and scope of the present invention.

Once both the lateral edges of the overlapped fabric product 20 are either sewn, stitched, glued, stapled, taped, fastened or permanently fused and bonded with one another, e.g., which typically occurs within a matter of a few seconds or so, and the pipe 92 and/or the fiber, woodchips, styrofoam, etc., 90 are inserted by the slidable tray 66 into the fin opening P, the control panel 12 then actuates the first drive 44 to move the fin sandwiching apparatus 6 a small distance away from the product dispensing stand 4. The control panel 12 then actuates the industrial hang tag guns, barb or wicket dispensing or fastening guns or devices 58, supported by the fin sandwiching apparatus 6, in order to stitch the opposed overlapped surfaces of the fabric product 20 to one another, in a conventional manner. Each one of the dispensed stitches, barbs, wickets, respectively provided by the four industrial hang tag guns, barb or wicket dispensing or fastening gun or devices 58, is typically formed at the interface or joint between the pipe 92 and/or the fiber, woodchips, styrofoam, etc., 90 loaded within the fin opening P and generally forms a boundary between the fiber, woodchips, styrofoam, etc., 90 and the pipe 92 as well as providing structural integrity.

Thereafter, the control panel 12 then actuates the first drive 44 to move the fin sandwiching apparatus 6 a very small distance away from the product dispensing stand 4. Such movement of the fin sandwiching apparatus 6 repositions each of the four industrial hang tag guns, barb or wicket dispensing or fastening guns or devices 58, supported by the fin sandwiching apparatus 6, at different locations relative to the fin member 46 prior to dispensing additional stitches, barbs, wickets for interconnecting the opposed overlapped surfaces of the fabric product 20 to one another, in a conventional manner. Again, each one of the stitches, barbs, wickets for interconnecting the opposed overlapped surfaces of the fabric product 20 to one another respectively provided by the industrial hang tag guns, barb or wicket dispensing or fastening guns or devices 58, is formed at the interface or joint between the pipe 92 and the fiber, woodchips, styrofoam, etc., 90 loaded within the fin opening P. The spaced apart stitches, barbs, wickets, etc. provide additional integrity to the fin member 46 which assists with subsequent handling and installation thereof. While the present embodiment illustrates two to four industrial hang tag guns, barb or wicket dispensing or fastening guns or devices 58, it is to be appreciated that the fin sandwiching and stitching apparatus 6 may employ more than four (or less than two) industrial hang tag guns, barb or wicket dispensing or fastening guns or devices 58, so long as a sufficient amount of stitches, barbs, wickets, etc. are formed for interconnecting the opposed surfaces of the overlapped fabric product 20 to one another, without departing from the spirit and scope of the present invention.

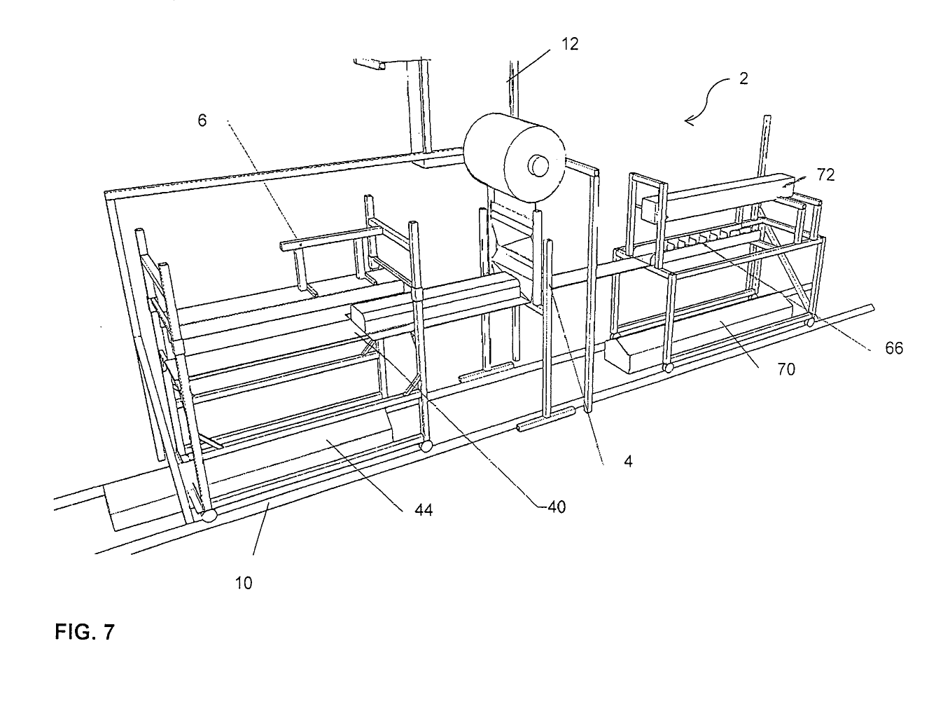

Next, the control panel 12 actuates the seal cylinder 52 to raise the vertically movable clamping device 50 away from and out of engagement with the generally planar table 40 of the fin sandwiching apparatus 6 and thereby permit removal of the formed section of the fin member 46. To assist with removal of the manufactured fin member 46, the control panel 12 then again actuates the first drive 44 to move the fin sandwiching apparatus 6 from its current position, located adjacent the product dispensing stand 4, into its retracted position spaced from the product dispensing stand 4. Since a trailing end of the fabric product 20 is still braked by the brake cylinder 30 biasing the first and the second cylindrical rods or rolls 28, 28′ of the product dispensing stand 4 into engagement with one another, as the fin sandwiching apparatus 6 is moved toward its retracted position spaced from the product dispensing stand 4 (see FIG. 7), the braking force applied to the fabric product 20 prevents further dispensing of the fabric product 20 from the product roll 32 and assists with retaining the formed fin member 46 of the fin structure 14 securely coupled to the product dispensing stand 4 and thereby prevents the manufactured fin member 46 from being transported along with the fin sandwiching apparatus 6 as it moves into its retracted position.

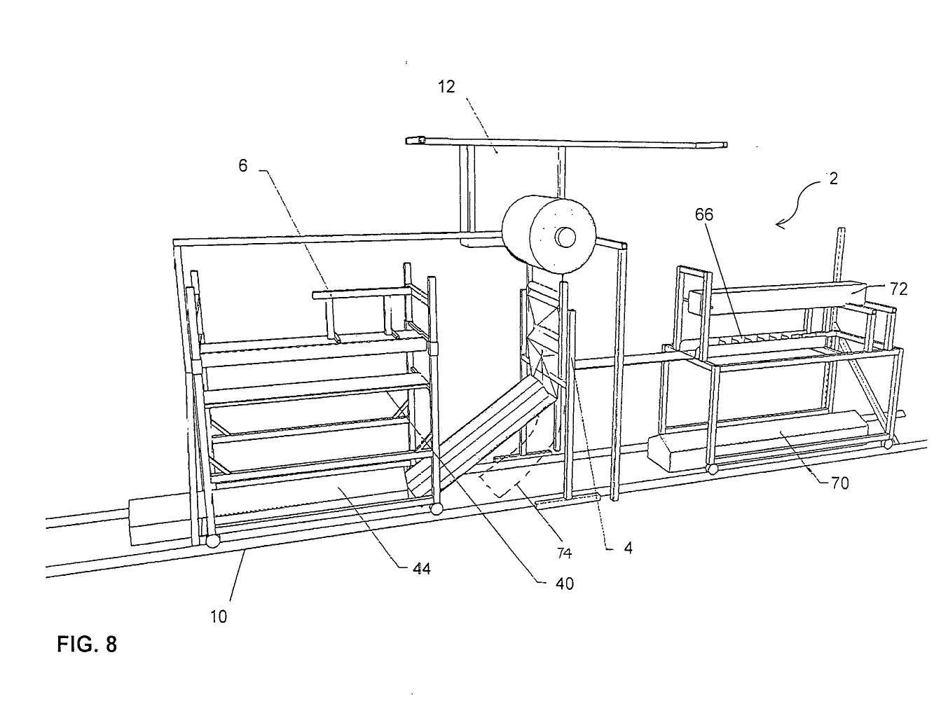

Generally before the fin sandwiching apparatus 6 reaches its fully retracted position, the manufactured fin member 46 of the fin structure 14 is pulled and eventually slides and falls off of the generally planar table 40 toward the floor 42. However, since the trailing end of the fabric product 20 is still connected to the roll 32 of the fabric product 20, the formed fin member 46 of the fin structure 14 is typically maintained in a generally vertical orientation and, as shown in FIG. 8, may rest against an inclined fin member ramp 74 which is supported by the product dispensing stand 4.

Thereafter, the above process shown in FIGS. 1-8 is again repeated to complete formation of a second manufactured fin member 46 of the fin structure 14 which will be integrally formed and connected with the first manufactured fin member 46 of the fin structure 14. That is, instead of cutting the fabric product 20 and beginning the process again by manufacturing a second separated fin member, the first and the second manufactured fin members 46 are integrally connected via a portion 73 of the same fabric product 20. By connecting the members initially, not only is a further step in the manufacturing process eliminated, but this also improves shipping, handling, installation and functionality of the fin structure 14.

After assembly of the second manufactured fin member 46 of the fin structure 14 is completed, the above process is again repeated to complete assembly of a third manufactured fin member 46 of the fin structure 14 which will be integrally formed and connected, via a second portion 73 of the same fabric product 20, with both the first and the second manufactured fin members 46 of the fin structure 14. Once again, after manufacture of the third manufacture fin member 46 of the fin structure 14 is completed, the above process is again repeated to complete assembly of a fourth manufactured fin member 46 of the fin structure 14 which will be integrally formed and connected, via a third portion 73 of the same fabric product 20, with the first, the second and the third manufactured fin members 46 of the fin structure 14. Once the fourth fin member 46 of the fin structure 14 is completed, this generally completes formation of fin member 46 (shown in FIG. 10) which only forms part of an ENVIROFIN® assembly 16.

The entire above process is then repeated to complete manufacture of the remaining portion of an ENVIROFIN® assembly 16, e.g., at least one other fin structure 14, as generally shown and disclosed in U.S. patent application Ser. No. 14/716,572 filed May 19, 2015 the disclosure of which is incorporated by reference into this application in its entirety. The two fin structures 14, during installation, are wrapped around a centrally located fin distribution unit 76, as generally shown in FIG. 11, which is designed to supply fluid to each one of the fin members 46. Thereafter, the above process is then again and again repeated to complete manufacture of two more fin structures 14, as described above.

While the above process describes the manufacture of a fin structure 14 which typically includes four separate manufactured fin members 46, it is to be appreciated that the overall number of manufactured fin members 46, which form part of the fin structure 14 and ENVIROFIN® assembly 16, can vary from application to application without departing from the spirit and scope of the present invention. That is, the fin structure 14 generally comprises between two integrally manufactured fin members 46 and eight integrally manufactured fin members 46, but it is to be appreciated that the overall number of integrally manufactured fin members 46, which comprises part or all of the fin structure 14, can vary from application to application. Similarly, while the ENVIROFIN® assembly 16 generally comprises between one separately manufactured fin structure 14 and four separately manufactured fin structures 14, e.g., FIG. 11 shows two separate fin structures 14 and 14′, it is also to be appreciated that the overall number of separately manufactured fin structures 14, which comprise part of the ENVIROFIN® assembly 16, can also vary from application to application.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

Wherefore, I/we claim:

1. A fin assembly apparatus for manufacture of a fin assembly, the fin assembly apparatus comprising:
a product dispensing stand for supporting a fabric product,
a pair of spaced apart guide tracks for supporting a movable fin sandwiching apparatus and a movable fin insertion apparatus with the product dispensing stand being located therebetween,
the movable fin insertion apparatus facilitating overlapping of the fabric product and formation of a fin opening,
the movable fin sandwiching apparatus facilitating formation of a fin member, and
a control panel for controlling operation of the fin assembly apparatus during manufacture of the fin assembly.

2. The fin assembly apparatus according to claim 1, wherein the product dispensing stand is stationary and facilitates periodically dispensing fabric product, and the product dispensing stand generally comprises a framework which supports at least one roll that facilitates dispensing of the fabric product during manufacture of the fin assembly.

3. The fin assembly apparatus according to claim 2, wherein the movable fin insertion apparatus is movable both toward the product dispensing stand into an extended position and movable away from the product dispensing stand into a retracted position, and
the movable fin sandwiching apparatus is movable both toward the product dispensing stand into an extended position and movable away from the product dispensing stand into a retracted position.

4. The fin assembly apparatus according to claim 2, wherein the movable fin sandwiching apparatus supports a table, a movable clamping device is located adjacent the table, and the movable clamping device is movable both toward the table into an extended position and movable away from the table into a retracted position.

5. The fin assembly apparatus according to claim 2, wherein the support framework of the product dispensing includes a base and at least one support which is permanently attached to and extends from the base, an arm is connected to a remote end of the at least one support for supporting a product roll supporting the product fabric to be dispensed, and the at least one support also supports at least one roll which assists with dispensing of the fabric product during manufacture of the fin assembly.

6. The fin assembly apparatus according to claim 5, wherein the product dispensing stand further comprises a brake cylinder which is actuated by the control panel, and brake cylinder clamps the fabric product to prevent further dispensing of the fabric product from the product roll.

7. The fin assembly apparatus according to claim 2, wherein the fin insertion apparatus comprises a framework and a lower most portion of the framework of the fin insertion apparatus supports guide rollers which facilitate rolling of the fin insertion apparatus along the pair of spaced apart guide tracks.

8. The fin assembly apparatus according to claim 2, wherein the fin sandwiching apparatus comprises a framework and a lower most portion of the framework of the fin sandwiching apparatus supports guide rollers which facilitate rolling of the fin sandwiching apparatus along the pair of spaced apart guide tracks.

9. The fin assembly apparatus according to claim 4, wherein the table is planar and is supported by an intermediate section of the fin sandwiching apparatus, spaced from the spaced apart guide tracks, and the table has a width which is wider than a width of the fabric product.

10. The fin assembly apparatus according to claim 2, wherein the movable clamping device comprises an inverted U-shaped device which is supported by the framework of the fin sandwiching apparatus adjacent the table, the movable clamping device has a width which is less than a width of the fabric product, the movable clamping device is spaced from the table so as to define an adjustable cavity therebetween which facilitates assembly of the fin assembly, and an extended position in which the movable clamping device is brought into contact with the table and reduces a size of the cavity which facilitates permanently securing overlapped lateral edges of the fabric product with one another.

11. The fin assembly apparatus according to claim 10, wherein the fin sandwiching apparatus further comprises at least one fastening device for fastening the overlapped lateral edges of the fabric product with one another when the movable clamping device is brought into contact with the table.

12. The fin assembly apparatus according to claim 7, wherein the fin insertion apparatus comprises a tongue member which is supported by an intermediate section of the framework of the fin insertion apparatus and projects from a leading end thereof, the tongue member extends parallel to the table of the fin sandwiching apparatus but is displaced slightly therefrom so as to permit relative movement of the tongue member with respect to the table, and during operation, as the fin insertion apparatus moves relative to the table of the fin sandwiching apparatus, a leading edge of the tongue member feeds the fabric product into a cavity defined by the fin sandwiching apparatus.

13. The fin assembly apparatus according to claim 12, wherein the leading edge of the tongue member is provided with one of a roller or an anti-friction layer or coating.

14. The fin assembly apparatus according to claim 12, wherein a slidable tray is supported by the framework of the fin insertion apparatus and is slidable along a surface of the tongue member into the cavity defined by the fin sandwiching apparatus.

15. The fin assembly apparatus according to claim 14, wherein the slidable tray is equipped with a plurality of spaced apart hinge members which each extend outwardly from a first side wall thereof and partially across a width of the slidable tray so as to form a gap between a leading edge of the extended plurality of spaced apart hinge members and a second opposed side wall of the slidable tray, and the gap is sufficiently sized to accommodate at least one perforated plastic pipe.

16. The fin assembly apparatus according to claim 15, wherein, during movement of the fin insertion apparatus into is retracted position, the plurality of spaced apart hinge members fold generally parallel to the first side wall so as to facilitate withdrawal of the slidable tray without removing any loaded fiber, woodchips, or styrofoam which are loaded by the plurality of spaced apart hinge members.

17. The fin assembly apparatus according to claim 2, wherein a first drive is coupled to the fin sandwiching apparatus for conveying the fin sandwiching apparatus along the pair of spaced apart guide tracks into either the extended position, located closely adjacent to the product dispensing stand, or the retracted position, located remote from the product dispensing stand.

18. The fin assembly apparatus according to claim 17, wherein a second drive is coupled to the fin insertion apparatus for conveying the fin insertion apparatus along the pair of spaced apart guide tracks into either the extended position, located closely adjacent to the product dispensing stand, or the retracted position, located remote from the product dispensing stand.

19. The fin assembly apparatus according to claim 18, wherein a third drive is supported by an upper portion of the framework of the fin insertion apparatus for conveying the slidable tray along the surface of the tongue member, the third drive facilitates conveying the slidable tray from its retracted position, located adjacent the trailing end of the fin insertion apparatus, into the extended position, located adjacent the leading end of and generally overlying the tongue member, for inserting both a pipe and/or loose material into a partially formed fin member.

20. A method of manufacturing a fin assembly via a fin assembly apparatus, the method comprising:
supporting a fabric product via a product dispensing stand,
supporting a movable fin sandwiching apparatus and a movable fin insertion apparatus on a pair of spaced apart guide tracks with the product dispensing stand being located therebetween,
moving the movable fin insertion apparatus relative to the product dispensing stand to overlapping the fabric product and form a fin opening,
sandwiching the fin opening, via the movable fin sandwiching apparatus, to form a fin member, and
controlling operation of the fin assembly apparatus, via a control panel, during manufacture of the fin assembly.
